(19) United States
(12) Patent Application Publication
(10) Pub. No.: US 2026/0219658 A1
(43) Pub. Date: Jul. 30, 2026

(54) MULTI-OBJECTIVE REINFORCEMENT LEARNING-BASED DISASSEMBLY LINE BALANCING OPTIMIZATION METHOD, SYSTEM, AND MEDIUM

(71) Applicant: QINGDAO UNIVERSITY OF TECHNOLOGY, Qingdao (CN)

(72) Inventors: Jinlong Wang, Qingdao (CN); Min Li, Qingdao (CN); Fanyun Meng, Qingdao (CN); Yuanyuan Zhang, Qingdao (CN); Xiaoyun Xiong, Qingdao (CN); Haoran Zhao, Qingdao (CN); Xiaoqi Zhao, Qingdao (CN)

(21) Appl. No.: 19/578,820

(22) Filed: Mar. 25, 2026

(51) Int. Cl. G05B 19/418; G06N 3/048; G06N 3/092

(52) U.S. Cl. CPC G05B 19/41885; G06N 3/048; G06N 3/092

(57) ABSTRACT

A multi-objective reinforcement learning-based disassembly line balancing optimization method. By obtaining input data and performing preprocessing, a state space, an action space, and an objective function are constructed; a multi-objective deep Q-network algorithm (MO-DQN algorithm) is adopted to introduce a preference vector to dynamically adjust objective weights, and a model is trained by combining an E-greedy strategy and a non-dominated sorting genetic algorithm II (NSGA-II) to optimize multiple objectives; and an optimal policy generated by the multi-objective reinforcement learning model that is trained is applied to task assignment in an actual disassembly line. The method is capable of dynamically handling objective conflicts, automatically adapting to situational changes, and improving the efficiency of task scheduling and resource allocation.

### TECHNICAL FIELD

The present application relates to the technical field of data processing, and particularly relates to a multi-objective reinforcement learning-based disassembly line balancing optimization method, system, and medium.

### BACKGROUND

Traditional heuristic algorithms are widely used in disassembly line balancing problems, primarily relying on rules of thumb and regulations for task scheduling and resource allocation. Although these methods can effectively optimize system performance in a static environment, their limitations gradually emerge when facing uncertainty and dynamic changes in a disassembly process. Specifically, the traditional heuristic algorithms cannot respond in real time to task time fluctuation, temporary change of resources, or interference from other environmental factors, resulting in the possible failure of an original balancing scheme when the disassembly task changes, and the inability to perform effective dynamic rebalancing. Therefore, although heuristic algorithms can exhibit certain advantages in some stable environments, their adaptability and robustness are limited in complex and dynamic task environments.

Compared with the traditional heuristic algorithms, reinforcement learning (RL) methods enable self-adjustment of policies in more complex and dynamic environments through interactive learning between an agent and a disassembly line balancing environment, exhibiting better flexibility and adaptive capability. However, traditional reinforcement learning algorithms still have significant defects in handling multi-objective optimization problems. Typically, the traditional RL methods perform optimization by weighting multiple objectives and fixing the weights; however, this approach cannot flexibly adjust a relative importance of various objectives according to an actual demand. In a disassembly task, conflicts and competitive relationships often exist among different objectives. Since the weights of the traditional RL methods after weighting the objectives are fixed, a dynamic trade-off among the objectives cannot be performed; therefore, when facing complex changes of the environment, these methods are difficult to effectively adapt to real-time changes of the task and the actual demand.

Therefore, the applications of the traditional heuristic algorithms and reinforcement learning methods in disassembly line balancing both face many challenges, especially in terms of multi-objective optimization and dynamic environment adaptability, lacking sufficient flexibility and adjustment capability.

### SUMMARY

The technical problem to be solved by the present application is to overcome the deficiencies of the prior art. The present application provides a multi-objective reinforcement learning-based disassembly line balancing optimization method, system, and medium. By introducing a preference vector, objective weights can be dynamically adjusted according to specific requirements of a task, thereby realizing efficient multi-objective optimization. This not only effectively handles conflicts among objectives, but also automatically adjusts optimization policies according to changes in different situations, significantly improving the efficiency of task scheduling and resource allocation in a disassembly task.

To achieve the above objective, a first aspect of the present application provides a multi-objective reinforcement learning-based disassembly line balancing optimization method, comprising the following steps:
S1, obtaining input data and preprocessing:
obtaining various types of data during a task execution process of a disassembly task and performing preprocessing, recording a disassembly precedence constraint, constructing a disassembly precedence constraint matrix, obtaining a hazardous property as well as a demand property of the disassembly task, and obtaining a disassembly time, a disassembly cost, and a disassembly energy consumption of different disassembly tasks on a manual workstation and a robotic workstation, respectively;
S2, constructing a state space, an action space, and an objective function, and deploying a training environment:
wherein the state space comprises a plurality of state features, and the state features comprise at least one of the following states: a workstation load state, a robot load state, a task assignment state, a predecessor task completion state, a successor task heuristic state, a task-station fitting state, and a cycle offset state; the action space comprises a plurality of action policies, and the action policies comprise at least one of the following policies: a longest processing time (LPT) first policy, a shortest processing time (SPT) first policy, a least predecessors (LP) first policy, a most successors (MS) first policy, an optimal cycle time matching (OCTM) policy, and a random policy; an objective function is designed based on three objectives of a number of workstations, the disassembly cost, and the disassembly energy consumption, and a multi-objective reinforcement learning model is constructed based on a multi-objective deep Q-network algorithm (MO-DQN algorithm);
S3, training the multi-objective reinforcement learning model:
the multi-objective reinforcement learning model introduces a preference vector through the MO-DQN algorithm to dynamically adjust objective weights, calculates the objective function based on the disassembly data obtained in S1, optimizes a plurality of objectives in S2, selects an action policy by combining an &-greedy strategy and a non-dominated sorting genetic algorithm II (NSGA-II) to finally converge to an optimal model capable of balancing the plurality of objectives;
S4, applying an optimal policy generated by the multi-objective reinforcement learning model that is trained to task assignment in an actual disassembly line.

Optionally, in S2, constructing the state space based on a disassembly line balancing optimization problem comprises: the workstation load state represents a ratio of a total time consumption of tasks assigned to each current workstation to a theoretical cycle time, reflecting a load status among various workstations; the robot load state represents a total time consumption of tasks currently undertaken by each robot, and is used to measure the allocation balance of a multi-robot resource in a global scope; the task assignment state marks whether a task assignment is completed with a Boolean value to dynamically identify a current feasible task set, and serves as an important prerequisite for a subsequent action selection strategy; the predecessor task completion state is used to dynamically record whether a predecessor task of each task is completed to ensure the correctness of an execution order; the successor task heuristic state is used to represent a number of subsequent tasks activated after a current task is completed, reflecting the contribution of the task to the promotion of the overall scheduling; the task-station fitting state is used to measure whether the theoretical cycle time of a specific workstation is exceeded after a task is assigned to the specific workstation; and the cycle offset state is used to record a deviation between a load of a workstation with a heaviest load in a current system and the theoretical cycle time, serving as a global performance indicator of the scheduling performance.

Optionally, in S2, constructing the action space based on a disassembly line balancing optimization problem comprises: the longest processing time (LPT) first policy represents preferentially scheduling a task with a longest execution time among current executable tasks; the shortest processing time (SPT) first policy represents preferentially assigning a task with a shortest execution time among the current executable tasks; the least predecessors (LP) first policy represents preferentially scheduling a task with a minimum number of predecessor tasks among the current executable tasks; the most successors (MS) first policy represents selecting a task with a maximum potential impact and preferentially processing an upstream node of the task to reduce a scheduling depth; the optimal cycle time matching (OCTM) policy represents preferentially selecting a task assignment scheme to make a load of a target workstation close to the theoretical cycle time; and the random policy represents randomly selecting a task for assignment for exploring a new policy or serving as a benchmark for a control experiment.

Optionally, in S1, obtaining input data and performing preprocessing comprises:
deploying sensors on various workstations and robots of a disassembly line to monitor various types of data involved during a task execution process of a disassembly task in real time, including a task execution time, a workstation load, a robot load, and a task priority, collecting the various types of data and performing preprocessing.

Optionally, in S2, the objective function is denoted as:

$$R = - ( {w}_{1} {f}_{1} + {w}_{2} {f}_{2} + {w}_{3} {f}_{3} ) ;$$

wherein w₁, w₂, and w₃ are weight coefficients of various objectives and reflect a relative importance of the various objectives in decision-making to achieve a collaborative optimization among different objectives, f₁ denotes the number of workstations, f₂ denotes the disassembly cost, and f₃ denotes a disassembly energy consumption.

Optionally, the multi-objective reinforcement learning model comprises an agent and a disassembly line balancing environment that interact with each other, wherein the agent adopts a deep Q-network (DQN); the agent receives state features of the disassembly line balancing environment, and selects an action according to an action policy and the objective function; and the disassembly line balancing environment returns a reward and updates network parameters;

In S3, training the multi-objective reinforcement learning model comprises: during a training process, a multi-objective deep Q-network algorithm (MO-DQN algorithm) combines a plurality of objective values to form a Q-value function in a vector form, and uses different objective preference weights as conditional inputs during the training process to learn a generalization mapping from preferences to Q-values; in each round of environment interaction, a preference vector ω is sampled, the deep Q-network takes a concatenation of a state vector s and the preference vector ω as an input and outputs a multi-objective Q-value vector of each action according to a disassembly precedence constraint matrix, and a final action selection is performed by selecting the action policy through an ε-greedy strategy combined with a non-dominated sorting genetic algorithm II (NSGA-II); the NSGA-II performs non-dominated sorting on the multi-objective Q-value vector corresponding to the action and calculates a crowding distance to determine an optimal action.

Optionally, an architecture of the deep Q-network comprises an input layer, a hidden layer, and an output layer; the input layer concatenates the state vector s and the preference vector ω to form a mixed input with a dimension of a state dimension plus a preference vector dimension, that is, the state dimension plus an objective dimension; the hidden layer is a three-layer fully connected neural network adopting a ReLU activation function and adding a dropout to prevent overfitting; and the output layer outputs the multi-objective Q-value vector corresponding to each action for a subsequent action selection.

To achieve the above objective, a second aspect of the present application provides a multi-objective reinforcement learning-based disassembly line balancing optimization system, the optimization system comprises:
an acquisition unit configured to obtain input data and perform preprocessing by obtaining various types of data during a task execution process of a disassembly task and performing preprocessing, recording a disassembly precedence constraint, constructing a disassembly precedence constraint matrix, obtaining a hazardous property as well as a demand property of the disassembly task, and obtaining a disassembly time, a disassembly cost, and a disassembly energy consumption of different disassembly tasks on a manual workstation and a robotic workstation, respectively;
a construction unit configured to construct a state space, an action space, and a reward function, and deploy a training environment: the state space comprises a plurality of state features, and the state features comprise at least one of the following states: a workstation load state, a robot load state, a task assignment state, a predecessor task completion state, a successor task heuristic state, a task-station fitting state, and a cycle offset state; the action space comprises a plurality of action policies, and the action policies comprise at least one of the following policies: a longest processing time (LPT) first policy, a shortest processing time (SPT) first policy, a least predecessors (LP) first policy, a most successors (MS) first policy, an optimal cycle time matching (OCTM) policy, and a random policy; an objective function is designed based on three objectives of a number of workstations, the disassembly cost, and the disassembly energy consumption, and a multi-objective reinforcement learning model is constructed based on a MO-DQN algorithm;
a training unit configured to train the multi-objective reinforcement learning model, wherein the multi-objective reinforcement learning model introduces a preference vector through the MO-DQN algorithm to dynamically adjust objective weights, calculates the objective function based on the disassembly data obtained in S1, optimizes a plurality of objectives in S2, selects an action policy by combining an s-greedy strategy and a NSGA-II to finally converge to an optimal model capable of balancing the plurality of objectives;
an optimization unit configured to perform task scheduling and resource allocation optimization by applying an optimal policy generated by the multi-objective reinforcement learning model that is trained to task assignment in an actual disassembly line.

To achieve the above objective, a third aspect of the present application provides a computer-readable storage medium storing a computer program thereon, wherein the computer program, when executed by a processor, causes the processor to implement the method as described above.

By adopting the above technical solution, the present application has the following beneficial effects compared with the prior art:
By introducing the MO-DQN algorithm, the present application achieves dynamic optimization of task scheduling and resource allocation for multiple objective requirements in disassembly tasks, such as minimizing the number of workstations, minimizing the disassembly cost, and minimizing the disassembly energy consumption, and can effectively respond to problems of uncertainty and multiple objective conflicts in a human-robot collaborative disassembly line. By introducing the preference vector, weights of different objectives can be flexibly adjusted, conflicts among multiple objectives can be balanced in real time, intelligent capability and flexibility of a disassembly line system are improved, and disassembly operation efficiency is effectively optimized.

Specific implementations of the present application are further described in detail below in combination with accompanying drawings.

### BRIEF DESCRIPTION OF THE DRAWINGS

The accompanying drawings serve as a part of the present application to provide a further understanding of the present application. Schematic embodiments and descriptions of the present application are used to explain the present application, but do not constitute improper limitations on the present application. Obviously, the accompanying drawings in the following description are only some embodiments, and for those of ordinary skill in the art, other accompanying drawings can also be obtained based on these accompanying drawings without creative labor.

In the accompanying drawings:

FIG. 1 is a schematic flowchart of a multi-objective reinforcement learning-based disassembly line balancing optimization method in the present implementation;

FIG. 2 is a schematic framework diagram of a reinforcement learning framework of a multi-objective reinforcement learning-based disassembly line balancing optimization method in the present implementation;

FIG. 3 is a schematic framework diagram of a MO-DQN algorithm of a multi-objective reinforcement learning-based disassembly line balancing optimization method in the present implementation;

FIG. 4 is a reward chart of training processes of the three algorithms of MO-DQN, MO-A2C, and MO-DDPG in a multi-objective reinforcement learning task in the present implementation;

FIG. 5 is a structural schematic diagram of a multi-objective reinforcement learning-based disassembly line balancing optimization system in the present implementation.

### DETAILED DESCRIPTION OF THE DISCLOSURE

To make the objectives, technical solutions, and advantages of the embodiments of the present application clearer, the technical solutions in the embodiments of the present application will be described clearly and completely in conjunction with the accompanying drawings in the embodiments of the present application. The following embodiments are used to illustrate the present application, but are not intended to limit the scope of the present application.

The present application aims to solve a multi-objective reinforcement learning-driven dynamic disassembly line balancing optimization problem, particularly for problems of uncertainty and multi objective conflicts faced in a human-robot collaborative disassembly line. Currently, conventional heuristic algorithms primarily rely on rules of thumb when processing disassembly line balancing, making it difficult to cope with dynamic changes such as task time fluctuation and uneven resource allocation, and lacking an ability to adjust uncertainty during a disassembly process in real time. At the same time, a traditional reinforcement learning method usually relies on a simple weighting mode with fixed weights; the traditional reinforcement learning method exhibits lower flexibility and adaptability when facing changes and conflicts among multiple objectives in a task. Therefore, traditional methods often fail to perform optimization effectively in a dynamic environment.

To overcome this limitation, the present application introduces a multi-objective deep reinforcement learning algorithm, namely, a multi-objective deep Q-network algorithm (MO-DQN algorithm), and combines multi-objective requirements in disassembly tasks, such as minimizing a number of workstations, minimizing a disassembly cost, and minimizing a disassembly energy consumption, to optimize task scheduling and resource allocation by using the MO-DQN algorithm. By introducing a preference vector, the MO-DQN algorithm can dynamically adjust an objective weight of each objective to flexibly respond to conflicts between objectives and adapt to changes during a task execution process. This method provides a more intelligent and flexible dynamic balancing solution for the multi-objective optimization problem in a disassembly line, significantly improving adaptability and optimization capability of a system in a complex and dynamic environment.

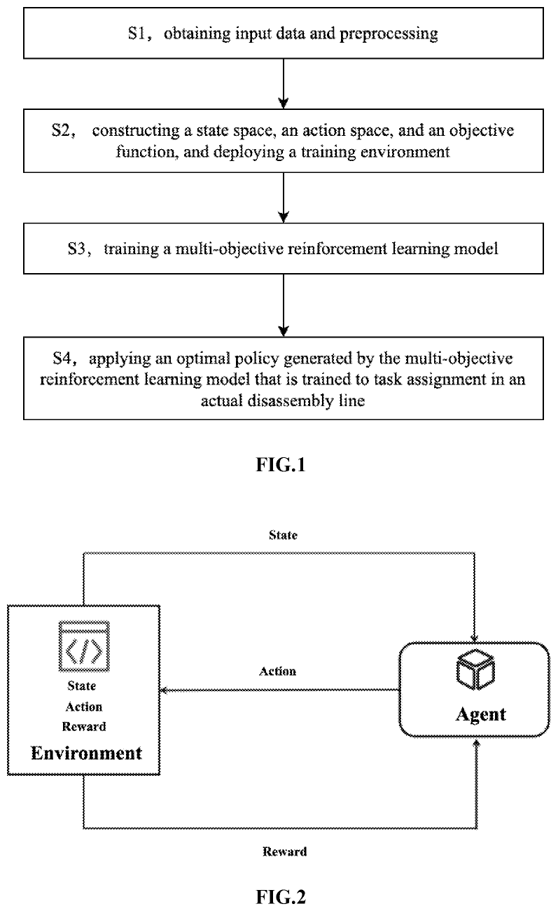

Based on this, referring to FIG. 1 to FIG. 4, the present application provides a multi-objective reinforcement learning-based disassembly line balancing optimization method, comprising the following steps:
S1, obtaining input data and performing preprocessing:
obtaining various types of data during a task execution process of a disassembly task and performing preprocessing, recording a disassembly precedence constraint, constructing a disassembly precedence constraint matrix, obtaining a hazardous property as well as a demand property of the disassembly task, and obtaining a disassembly time, a disassembly cost, and a disassembly energy consumption of different disassembly tasks on a manual workstation and a robotic workstation, respectively;
S2, constructing a state space, an action space, and an objective function, and deploying a training environment:
the state space comprises a plurality of state features, and the state features comprise at least one of the following states: a workstation load state, a robot load state, a task assignment state, a predecessor task completion state, a successor task heuristic state, a task-station fitting state, and a cycle offset state; the action space comprises a plurality of action policies, and the action policies comprise at least one of the following policies: a longest processing time (LPT) first policy, a shortest processing time (SPT) first policy, a least predecessors (LP) first policy, a most successors (MS) first policy, an optimal cycle time matching (OCTM) policy, and a random policy; an objective function is designed based on three objectives of a number of workstations, the disassembly cost, and the disassembly energy consumption, and a multi-objective reinforcement learning model is constructed based on a MO-DQN algorithm;
S3, training the multi-objective reinforcement learning model:
the multi-objective reinforcement learning model introduces a preference vector through the MO-DQN algorithm to dynamically adjust objective weights, calculates the objective function based on the disassembly data obtained in S1, optimizes a plurality of objectives in S2, selects an action policy by combining an &-greedy strategy and a non-dominated sorting genetic algorithm II (NSGA-II) to finally converge to an optimal model capable of balancing the plurality of objectives;
S4, task scheduling and resource allocation optimization:
applying an optimal policy generated by the multi-objective reinforcement learning model that is trained to task assignment in an actual disassembly line.

It should be noted that an execution entity of the multi-objective reinforcement learning-based disassembly line balancing optimization method in the present embodiment is an electronic device, a component in an electronic device, an integrated circuit, or a chip. The electronic device may be a mobile electronic device or a non-mobile electronic device. Exemplarily, the mobile electronic device may be a mobile phone, a tablet computer, a laptop computer, a palmtop computer, an in-vehicle electronic device, a wearable device, or the like; the non-mobile electronic device may be a server, a personal computer, or the like, which is not specifically limited in the present application. In the following, the server is taken as an example of the execution entity to describe the multi-objective reinforcement learning-based disassembly line balancing optimization method in the present embodiment.

In addition, terms “first” and “second” are used for descriptive purposes only and cannot be understood as indicating or implying relative importance or implicitly specifying a quantity of technical features indicated. Thus, a feature defined as “first” or “second” may explicitly or implicitly include the at least one feature. In the description of the embodiments of the present application, a meaning of “a plurality of” is two or more, unless otherwise explicitly and specifically defined.

The present embodiment improves upon a disassembly scenario by introducing a manual backup mechanism to ensure continuity of the disassembly process and constructing the state space and the action space that characterize a current scenario in a fine-grained manner. The multi-objective reinforcement learning algorithm adopted in the present embodiment, namely, the MO-DQN algorithm, is different from previous multi-objective optimization using weighted summation; instead, the MO-DQN algorithm takes objective values of a plurality of objective functions that are returned as a reward vector to train one policy for all preference vectors, and meanwhile, introduces the NSGA-II during action selection to help select an optimal solution under multiple objectives.

The present embodiment, by introducing the multi-objective deep reinforcement learning algorithm, namely, the MO-DQN, can not only optimize a trade-off between multiple objectives but also dynamically adjust a task assignment policy to cope with uncertainty and interference generated during the disassembly process. The MO-DQN provides a solution idea of embedding objective preference weights into a policy structure. By constructing a preference-conditioned Q-function Q (s, a, ω), this method can not only process multi-objective tasks but also possesses excellent full-space generalization capability and policy reuse capability. Combined with a “divergent feature” of the disassembly task, this method can quickly adapt to requirements of the user for trade-offs among different objectives, such as flexibly switching between a “minimum disassembly energy consumption” policy or a “minimum disassembly cost” policy, thereby improving intelligent capability and real-time responsiveness of a disassembly decision-making system.

In a practical application, S1 of obtaining input data and performing preprocessing comprises: sensors are deployed on various workstations and robots of the disassembly line to monitor various types of data during a task execution process of the disassembly task in real time, including information such as an execution time of each task, a workstation load, a robot load, and a task priority. Data from different disassembly tasks are collected and preprocessed to ensure quality and consistency of the data. Preprocessing of the data includes operations such as denoising and normalization to provide high-quality input for a subsequent multi-objective reinforcement learning model.

As a specific implementation, S2 of constructing a state space, an action space, and an objective function, and deploying a training environment comprises: at this stage, a multi-dimensional state space is constructed, covering critical elements in a task scheduling process, such as a workstation load state, a robot load state, and a task assignment state. Based on real-time data collected, a simulated disassembly environment is generated for training the multi-objective reinforcement learning model.

To realize global perception and precise decision-making capability of a reinforcement learning agent for a complex disassembly system, a high-dimensional state space vector structure covering multi-dimensional critical information is constructed. The high-dimensional state space vector structure comprehensively characterizes core elements such as structural features, resource load, logical dependency, and scheduling potential during the task scheduling process, aiming to provide sufficient environment representation capability and learning support for a policy network.

As a specific implementation, constructing the state space based on the disassembly line balancing optimization problem in S2 comprises: a workstation load state represents a ratio of a total time consumption of tasks currently assigned to each workstation to a theoretical cycle time, reflecting a relative load status among various workstations; a robot load state represents a total time consumption of tasks currently undertaken by each robot, which is used to measure a distribution balance of multi-robot resources in a global scope; a task assignment state marks whether a task has completed assignment with a Boolean value, which is used to dynamically identify a current feasible task set and is an important prerequisite for a subsequent action selection policy; a predecessor task completion state is used to dynamically record whether a predecessor task of each task has been completed to ensure correctness of an execution order of tasks; a successor task heuristic state is used to characterize a number of subsequent tasks that can be activated after a current task is completed, reflecting a contribution of the task to advancement of overall scheduling; a task-station fitting state is used to measure whether a specific task will exceed the theoretical cycle time of a workstation after being assigned to the workstation; and a cycle offset state is used to record a deviation between a load of a workstation with a heaviest load in a current system and the theoretical cycle time, serving as a global performance indicator of a scheduling performance.

To improve training stability and convergence efficiency of a neural network, all state features are normalized before being input to uniformly map a value range of the state features to an interval of [0, 1], so as to avoid a gradient instability problem caused by inconsistent variable scales. Furthermore, considering that a number of tasks may vary in different task instances, in order to ensure that an input dimension of the neural network structure is fixed, a zero-padding mechanism is adopted to expand and pad a state vector, such that the multi-objective reinforcement learning model can maintain structural consistency and training compatibility under different problem scales.

It should be noted that a meaning of a task-station fitting state and a cycle offset state is to ensure that a disassembly time of a workstation does not exceed a cycle time, and is as close to the cycle time as possible, so as to achieve load balancing. Ensuring that the disassembly time of the workstation does not exceed the cycle time is a most basic indicator in a technical field of disassembly line balancing. Load balancing is also a common indicator in the technical field of disassembly line balancing.

Considering that the number of tasks for disassembly is massive and complex dependencies exist among the tasks for disassembly, if an action space is directly modeled as a discrete combination of a “task-station-robot” triplet, a dimension of the action space will grow exponentially with a task scale and resource allocation, which easily leads to problems such as dimension explosion of training samples, difficulty in convergence of a policy network, and low sample efficiency. To effectively alleviate a computational burden and learning obstacles brought by a high-dimensional action space, the present embodiment introduces an abstract modeling method of the action space based on a heuristic policy. Specifically, a raw action space is compressed and mapped into following representative task assignment rules, where each action policy represents a typical scheduling logic, thereby achieving effective compression of an action dimension and enhancement of semantic expression.

In a practical application, in S2, the longest processing time (LPT) first policy represents that a task expected to take a longest time is preferentially scheduled, aiming to reduce system congestion and release high-occupancy resources; the shortest processing time (SPT) first policy represents that a short task is preferentially assigned to quickly fill an idle workstation and improve a scheduling response frequency within a unit time; the least predecessors (LP) first policy represents that a task with least dependencies is preferentially scheduled to accelerate unfolding of a task network; the most successors (MS) first policy represents that a task with a maximum potential impact is selected and an upstream node of the task is preferentially processed to reduce a scheduling depth; the optimal cycle time matching (OCTM) policy represents that a task assignment scheme is preferentially selected to make a load of a target workstation close to a theoretical cycle time, so as to improve pacing balance; and the random policy represents that a task is randomly selected for assignment, which is used to explore a new policy or serve as a benchmark for a control experiment.

It should be noted that the introduction of the abstract action space not only significantly compresses a policy learning dimension and improves a convergence speed and sample efficiency, but also enhances interpretability and versatility of a policy behavior through semantic encoding of different task assignment rules. During a training process, the policy network learns to judge performance of each action policy in different situations through perception of a current system state, and dynamically selects an optimal assignment logic, thereby achieving environment-driven evolution and real-time switching of a scheduling policy.

In multi-objective reinforcement learning modeling for a product disassembly line optimization problem, a design of an objective function is critical. To achieve comprehensive optimization of a disassembly system in three aspects of resource utilization, economic cost, and environmental impact, three core objectives are comprehensively considered: a number of workstations f₁, a disassembly cost f₂, and a disassembly energy consumption f₃. Compared with single-objective optimization, a policy learning mechanism based on multi-objective reinforcement learning can simultaneously trade off performance in multiple dimensions, improving robustness of solutions and practical feasibility.

As a specific implementation, since a potential competitive relationship exists among the three objective functions, the present embodiment adopts a weighted linear combination method to model multi-objective reinforcement learning. In a form of weighted combination, the objective function in S2 is denoted as:

$$R = - ( {w}_{1} {f}_{1} + {w}_{2} {f}_{2} + {w}_{3} {f}_{3} ) ;$$

Wherein w=[w₁, w₂, w₃] is a weight coefficient of each objective, reflecting a relative importance of each objective in decision-making, so as to achieve collaborative optimization among different objectives, f₁ denotes the number of workstations, f₂ denotes the disassembly cost, and f₃ denotes the disassembly energy consumption.

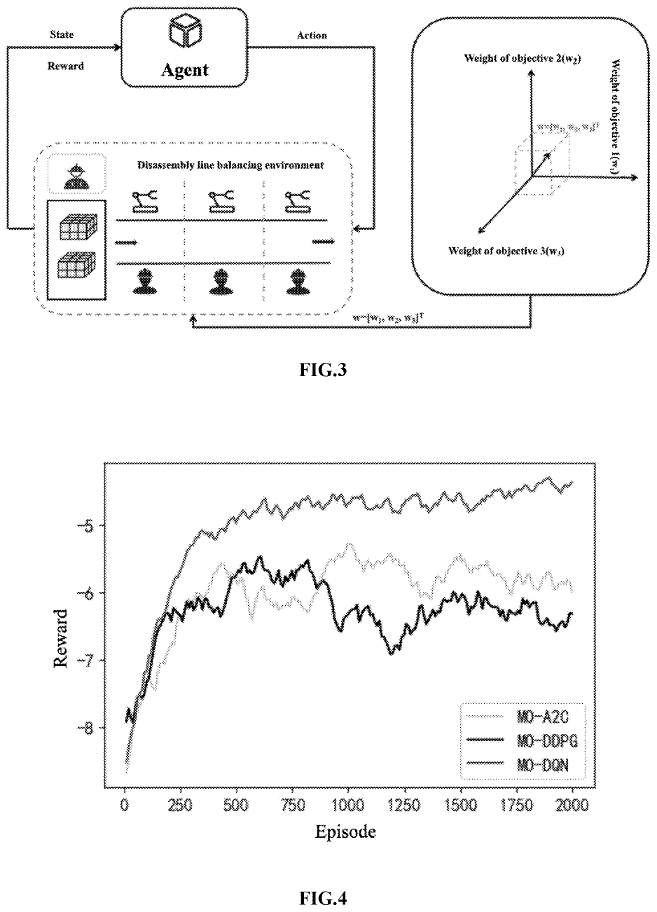

In conjunction with FIG. 3, the multi-objective reinforcement learning model constructed in the present embodiment comprises an agent and a disassembly line balancing environment, which constantly interact with each other, wherein the agent in the present embodiment adopts a deep Q-network (DQN), the agent receives state features of the disassembly line balancing environment, selects an action according to an action policy and the objective function, the disassembly line balancing environment returns a reward, and network parameters are updated.

In a practical application, training a multi-objective reinforcement learning model in S3 comprises: during the training process, combining a plurality of objective values to form a Q-value function in a vector form through a MO-DQN algorithm, and using different preference weights as conditional inputs during training to learn a generalization mapping from preference to Q-values.

In each round of environment interaction, a preference vector ω is sampled. The deep Q-network (DQN) takes a concatenation of a state vector s and the preference vector ω as an input, and outputs a multi-objective Q-value vector of each action according to a disassembly precedence constraint matrix. A final action selection is performed by selecting an action policy through an ε-greedy strategy combined with a non-dominated sorting genetic algorithm II (NSGA-II). The NSGA-II performs non-dominated sorting on the multi-objective Q-value vectors corresponding to actions and calculates the crowding distance of the multi-objective Q-value vectors to determine an optimal action.

The disassembly precedence constraint matrix is used to encode a sequential dependency between tasks (i.e., which tasks must be completed before other tasks). In the present embodiment, the disassembly precedence constraint matrix is integrated into the training process through state representation and an action mask, so as to ensure that the agent optimizes a multi-objective Q-value under a premise of satisfying the dependency.

As a specific implementation, an architecture of the deep Q-network (DQN) comprises an input layer, a hidden layer, and an output layer. The input layer concatenates the state vector s and the preference vector ω to form a mixed input with a dimension being a sum of a state dimension and a preference vector dimension, that is, a sum of the state dimension and an objective dimension; the hidden layer is a three-layer fully connected neural network, which adopts a ReLU activation function and uses dropout to prevent overfitting; and the output layer outputs the multi-objective Q-value vector corresponding to each action for subsequent action selection.

It should be noted that following mechanisms are adopted to enhance performance of the MO-DQN algorithm:

### 1. Experience Replay Mechanism:

A 5-tuple experience pool is constructed during the training process, and each sample comprises: a current state, an action, a vectorized reward, a next state, and a termination flag. Therein, the reward is a multi-dimensional vector, representing immediate feedback on each objective dimension respectively. An experience pool capacity is set to 100,000 samples, and parallel asynchronous sampling operations are supported. In each round of training, a certain number of trajectories are randomly extracted from the 5-tuple experience pool, and combined with a preference vector to construct a training sample batch.

### 2. Preference Vector Sampling Mechanism:

To ensure that the policy network has good adaptability to all possible combinations of objective weights, a preference vector ω is uniformly sampled from a unit hyperplane during the training process. For a three-dimensional objective, a large number of preference samples are generated by adopting a Dirichlet distribution or a method of uniformly sampling inside an equilateral triangle, so as to train the deep Q-network (DQN) with strong full-space generalization capability. This method enables the multi-objective reinforcement learning model that is trained to not only output a single policy but also output a customized action policy according to different weight preferences.

### 3. Action Selection Strategy:

During the training process, the E-greedy strategy is adopted to trade off exploration and exploitation:
(1) an action is randomly selected with a probability of ε, wherein an initial ε is set to 0.5 and is linearly decreased to 0.05 during the training process;
(2) an action that makes an inner product of ω and Q-vector maximum is selected with a probability of 1−ε, i.e., an optimal policy is selected based on a current preference.

In a test phase, a specific objective preference weight vector ω is input, and an action that makes a weighted Q-value maximum is directly selected, so as to achieve an optimal policy output under preference control.

### 4. Preference Self-Adaptation and Policy Generalization Capability:

Since the multi-objective reinforcement learning model learns a generalization mapping relationship from a preference vector to a policy, the multi-objective reinforcement learning model has extremely strong flexibility in actual deployment:
(1) a user can directly input a specific combination of objective weights, and a system quickly outputs a corresponding policy;
(2) when an environment changes or the objective weights are dynamically adjusted, no retraining is required, and a new policy can be generated only by adjusting the preference vector ω, thereby achieving real-time adaptation and high responsiveness.

In a practical application, training a multi-objective reinforcement learning model in S3 comprises: during the training process, combining a plurality of objective values to form a Q-value function in a vector form through a MO-DQN algorithm, and using different preference weights as conditional inputs during training to learn a generalization mapping from preference to Q-values, comprising taking, by the deep Q-network (DQN), a concatenation of a state vector s and a preference vector ω as an input, outputting a Q-vector corresponding to each possible action, and finally performing action selection by performing non-dominated sorting on multi-objective Q-value vectors corresponding to the actions through a non-dominated sorting genetic algorithm II (NSGA-II) and calculating a crowding distance of the multi-objective Q-value vectors to determine an optimal action.

As a specific implementation, an architecture of the deep Q-network (DQN) comprises an input layer, a hidden layer, and an output layer. The input layer concatenates a state vector s and a preference vector ω to form a mixed input with a dimension being a sum of a state dimension and a preference vector dimension, that is, a sum of the state dimension and an objective dimension; the hidden layer is a three-layer fully connected neural network, which adopts a ReLU activation function and uses dropout to prevent overfitting; and the output layer outputs a multi-objective Q-value vector corresponding to each action for subsequent action selection.

In a practical application, training a multi-objective reinforcement learning model in S3 comprises: in each round of environment interaction, sampling a preference vector ω, inputting the current state s and the preference vector ω into the deep Q-network (DQN), outputting the multi-objective Q-value vector of each action according to a disassembly precedence constraint matrix, and selecting an action policy by adopting an ε-greedy strategy combined with the non-dominated sorting genetic algorithm II (NSGA-II).

In a practical application, after training, an optimal policy generated by a multi-objective deep Q-network algorithm (MO-DQN algorithm) is applied to task assignment in an actual disassembly line.

Specifically, after training, the optimal policy generated by the MO-DQN algorithm is applied to the task assignment in the actual disassembly line. Based on dynamicity of a reinforcement learning method, a system can respond in real time to uncertainty in a disassembly process, such as a fluctuation of task execution time and a problem of uneven resource allocation, thereby optimizing overall efficiency of the disassembly line. Such dynamic adjustment can not only optimize a load of each workstation and each robot, but also effectively reduce idle time in the disassembly process and improve resource utilization.

Compared with existing conventional methods, the present application adopts multi-objective reinforcement learning to solve a disassembly line balancing problem. By introducing a multi-objective optimization framework, the MO-DQN algorithm can dynamically trade off different objectives in a disassembly task, and adjust a policy according to real-time feedback to maximize overall system benefits. Furthermore, dynamic adjustment capability based on reinforcement learning enables the method to effectively deal with problems of constantly changing tasks and resource allocation in the disassembly process, and has strong adaptability and flexibility.

Referring to FIG. 5, based on the same inventive concept, the present application further provides a disassembly line balancing optimization system based on multi-objective reinforcement learning. The disassembly line balancing optimization system comprises:
an acquisition unit configured to obtain input data and preprocess: obtaining various types of data during a disassembly task execution process and performing preprocessing;
a construction unit configured to construct a state space, an action space, and a reward function, and deploy a training environment: the state space includes a plurality of state features, and the state features include a workstation load state, a robot load state, a task assignment state, a predecessor task completion state, a successor task heuristic state, a task-station fitting state, and a cycle offset state; the action space includes a plurality of action policies, and the action policies include a longest processing time (LPT) first policy, a shortest processing time (SPT) first policy, a least predecessors (LP) first policy, a most successors (MS) first policy, an optimal cycle time matching (OCTM) policy, and a random policy; and designing the reward function based on three core objectives of a number of workstations, a disassembly cost, and a disassembly energy consumption to construct the multi-objective reinforcement learning model;
a training unit configured to train the multi-objective reinforcement learning model: introducing the preference vector ω through the MO-DQN algorithm to dynamically adjust an objective weight and optimize a plurality of objectives in S2, and finally converging to an optimal model capable of balancing the plurality of objectives through the E-greedy strategy combined with the NSGA-II;
an optimization unit configured for task scheduling and resource allocation optimization: applying the multi-objective reinforcement learning model that is trained to the task assignment in the actual disassembly line.

The present application combines the multi-objective reinforcement learning with disassembly task scenario modeling to successfully construct a dynamic disassembly line balancing system. The dynamic disassembly line balancing system perceives the state space of critical resources such as tasks, robots, and workstations in depth, and adjusts an assignment and an execution order of disassembly tasks in real time, thereby improving adaptability and scheduling efficiency of the dynamic disassembly line balancing system. Different from a conventional single-objective reinforcement learning method, the MO-DQN algorithm considers multiple objectives such as the number of workstations, the disassembly cost, and the disassembly energy consumption by designing a multi-dimensional objective function and adopting a vectorized objective method, and can flexibly adjust an optimization policy according to different weight requirements. The method is particularly suitable for disassembly tasks with high complexity and uncertainty. In an actual refrigerator disassembly task, the MO-DQN algorithm demonstrates superior performance. Experimental verification shows that the MO-DQN algorithm not only effectively solves conflicts among multi-objectives, but also achieves collaborative optimization in multiple dimensions such as resource utilization, the disassembly energy consumption, and the disassembly cost. Experimental results further show that a policy network can gradually converge during the training process and flexibly adjust a policy output according to preferences of different objectives, showing good learning efficiency and convergence characteristics. The MO-DQN algorithm provides an efficient and intelligent multi-objective optimization scheme for disassembly tasks, has strong adaptability and real-time responsiveness, and can cope with dynamic changes in an actual disassembly environment. The method not only provides theoretical support for intelligent scheduling of an industrial disassembly line, but also lays a foundation for further promotion to a larger-scale industrial system.

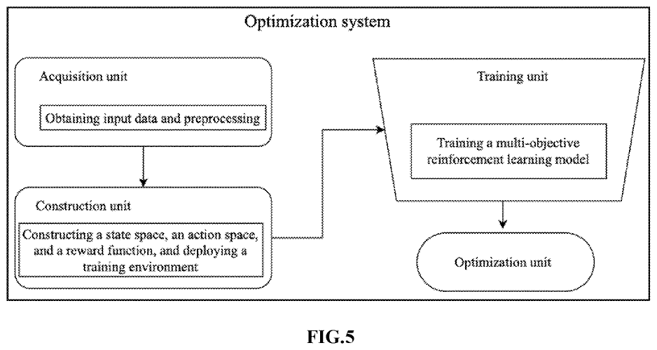

Referring to FIG. 4, a reward chart shows change trends of reward values of three algorithms, namely the MO-DQN algorithm, a multi-objective A2C algorithm (MO-A2C algorithm, i.e., multi-objective Advantage Actor-Critic), and a multi-objective DDPG algorithm (MO-DDPG algorithm, i.e., multi-objective Deep Deterministic Policy Gradient), during the training process. Therein, the MO-DQN algorithm shows a faster convergence speed and higher stability, and a final reward value of the MO-DQN algorithm is the highest, showing optimal performance; the MO-A2C algorithm converges faster in an initial stage but fluctuates in a middle stage; while the MO-DDPG algorithm has the slowest convergence speed and large fluctuations, and a final cumulative reward value of the MO-DDPG algorithm is the lowest. This indicates that learning efficiency and a policy optimization effect of the MO-DQN algorithm are superior to those of the other two algorithms in a disassembly line balancing environment.

Based on the same inventive concept, the present application further provides a computer-readable storage medium storing a computer program thereon. When the computer program is executed by a processor, the method as described above is implemented.

A program product of the present application for implementing the above method may adopt a compact disc read-only memory (CD-ROM) and include program code, and may run on a terminal device, such as a personal computer. However, the program product of the present application is not limited thereto. In the present application, the computer-readable storage medium may be any tangible medium containing or storing a program, and the program may be used by or used in combination with an instruction execution system, apparatus, or device.

It should be noted that the computer-readable storage medium may include a data signal propagated in a baseband or as part of a carrier wave, in which readable program code is carried. Such a propagated data signal may take a variety of forms, including but not limited to an electromagnetic signal, an optical signal, or any suitable combination of the above. The computer-readable storage medium may also be any readable medium other than the computer-readable storage medium, and the readable medium can send, propagate, or transmit a program for use by or in combination with the instruction execution system, apparatus, or device. The program code contained on the computer-readable storage medium may be transmitted by any appropriate medium, including but not limited to wireless, wired, optical cable, RF, etc., or any suitable combination of the above.

The above are only preferred embodiments of the present application and are not intended to limit the present application in any form. Although the present application has been disclosed as above with the preferred embodiments, the preferred embodiments are not intended to limit the present application. Any person skilled in the art, without departing from a scope of a technical solution of the present application, may use the technical content disclosed above to make some changes or modifications into equivalent embodiments with equivalent changes. Implementation schemes in the above embodiments may also be further combined or replaced. However, any simple modifications, equivalent changes, and decorations made to the above embodiments according to a technical essence of the present application, which do not depart from the content of the technical solution of the present application, still fall within a scope of the solution of the present application.

What is claimed is:

1. A multi-objective reinforcement learning-based disassembly line balancing optimization method, comprising:
S1, obtaining input data and preprocessing:
obtaining various types of data during a task execution process of a disassembly task and performing preprocessing, recording a disassembly precedence constraint, constructing a disassembly precedence constraint matrix, obtaining a hazardous property as well as a demand property of the disassembly task, and obtaining a disassembly time, a disassembly cost, and a disassembly energy consumption of different disassembly tasks on a manual workstation and a robotic workstation, respectively;
S2, constructing a state space, an action space, and an objective function, and deploying a training environment:
wherein the state space comprises a plurality of state features, and the state features comprise at least one of the following states: a workstation load state, a robot load state, a task assignment state, a predecessor task completion state, a successor task heuristic state, a task-station fitting state, and a cycle offset state; the action space comprises a plurality of action policies, and the action policies comprise at least one of the following policies: a longest processing time (LPT) first policy, a shortest processing time (SPT) first policy, a least predecessors (LP) first policy, a most successors (MS) first policy, an optimal cycle time matching (OCTM) policy, and a random policy; the objective function is designed based on three objectives of a number of workstations, the disassembly cost, and the disassembly energy consumption, and a multi-objective reinforcement learning model is constructed based on a multi-objective deep Q-network algorithm (MO-DQN algorithm);
the objective function in S2 is denoted as:
$$R = - ( {w}_{1} {f}_{1} + {w}_{2} {f}_{2} + {w}_{3} {f}_{3} ) ;$$
wherein w₁, w₂, and w₃ are weight coefficients of various objectives and reflect a relative importance of the various objectives in decision-making to achieve a collaborative optimization among different objectives, f₁ denotes the number of workstations, f₂ denotes the disassembly cost, and f₃ denotes the disassembly energy consumption;
S3, training the multi-objective reinforcement learning model:
wherein the multi-objective reinforcement learning model introduces a preference vector through the MO-DQN algorithm to dynamically adjust objective weights, calculates the objective function based on the disassembly data obtained in S1, optimizes a plurality of objectives in S2, selects an action policy by combining an e-greedy strategy and a non-dominated sorting genetic algorithm II (NSGA-II), and finally converges to an optimal model capable of balancing the plurality of objectives;
during a training process, the MO-DQN algorithm combines a plurality of objective values to form a Q-value function in a vector form, uses different preference weights as conditional inputs during the training process to learn a generalization mapping from preferences to Q-values, and the NSGA-II performs non-dominated sorting on a multi-objective Q-value vector corresponding to an action and calculates a crowding distance to determine an optimal action; and
S4, applying an optimal policy generated by the multi-objective reinforcement learning model that is trained to task assignment in an actual disassembly line.

2. The method according to claim 1, comprising constructing the state space based on a disassembly line balancing optimization problem, wherein the workstation load state represents a ratio of a total time consumption of tasks assigned to each current workstation to a theoretical cycle time, reflecting a load status among various workstations; the robot load state represents a total time consumption of tasks currently undertaken by each robot, and is used to measure an allocation balance of a multi-robot resource in a global scope; the task assignment state marks whether a task assignment is completed with a Boolean value to dynamically identify a current feasible task set, and serves as an important prerequisite for a subsequent action selection strategy; the predecessor task completion state is used to dynamically record whether a predecessor task of each task is completed to ensure a correctness of an execution order; the successor task heuristic state is used to represent a number of subsequent tasks activated after a current task is completed, reflecting the contribution of the task to the promotion of an overall scheduling; the task-station fitting state is used to measure whether the theoretical cycle time of a specific workstation is exceeded after a task is assigned to the specific workstation; and the cycle offset state is used to record a deviation between a load of a workstation with a heaviest load in the current system and the theoretical cycle time, serving as a global performance indicator of the scheduling performance.

3. The method according to claim 1, comprising constructing the action space based on a disassembly line balancing optimization problem in S2, wherein the longest processing time (LPT) first policy represents preferentially scheduling a task with a longest execution time among current executable tasks; the shortest processing time (SPT) first policy represents preferentially assigning a task with a shortest execution time among the current executable tasks; the least predecessors (LP) first policy represents preferentially scheduling a task with a minimum number of predecessor tasks among the current executable tasks; the most successors (MS) first policy represents selecting a task with a maximum potential impact and preferentially processing an upstream node of the task to reduce a scheduling depth; the optimal cycle time matching (OCTM) policy represents preferentially selecting a task assignment scheme to make a load of a target workstation close to the theoretical cycle time; and the random policy represents randomly selecting a task for assignment for exploring a new policy or serving as a benchmark for a control experiment.

4. The method according to claim 1, comprising obtaining the input data and preprocessing in S1, which further comprises:
deploying a sensor on each workstation and each robot of the disassembly line, monitoring various types of data involved in the task execution process of the disassembly task in real time, wherein the various types of data comprise a task execution time, a workstation load, a robot load, and a task priority, and collecting the various types of data to perform preprocessing.

5. The method according to claim 3, wherein the multi-objective reinforcement learning model comprises an agent and a disassembly line balancing environment that interact with each other, wherein the agent adopts a deep Q-network (DQN); the agent receives the state features of the disassembly line balancing environment, and selects an action according to the action policy and the objective function; the disassembly line balancing environment returns a reward and updates network parameters; and
wherein in each round of environment interaction, a preference vector w is sampled, the DQN takes a concatenation of a state vector s and the preference vector w as an input to output the multi-objective Q-value vector of each action according to the disassembly precedence constraint matrix, and a final action selection is performed by selecting the action policy through the ε-greedy strategy combined with the NSGA-II.

6. The method according to claim 5, wherein an architecture of the DQN comprises an input layer, a hidden layer, and an output layer; the input layer concatenates the state vector s and the preference vector ω to form a mixed input with a dimension being a state dimension plus a preference vector dimension, which is the state dimension plus an objective dimension; the hidden layer is a three-layer fully connected neural network, which adopts a ReLU activation function and introduces a dropout to prevent overfitting; and the output layer outputs a multi-objective Q-value vector corresponding to each action for a subsequent action selection.

7. A multi-objective reinforcement learning-based disassembly line balancing optimization system, comprising:
an acquisition unit configured to obtain input data and perform preprocessing by obtaining various types of data during a task execution process of a disassembly task and performing preprocessing, recording a disassembly precedence constraint, constructing a disassembly precedence constraint matrix, obtaining a hazardous property as well as a demand property of the disassembly task, and obtaining a disassembly time, a disassembly cost, and a disassembly energy consumption of different disassembly tasks on a manual workstation and a robotic workstation, respectively;
a construction unit configured to construct a state space, an action space, and a reward function, and deploy a training environment, wherein the state space comprises a plurality of state features, and the state features comprise at least one of the following states: a workstation load state, a robot load state, a task assignment state, a predecessor task completion state, a successor task heuristic state, a task-station fitting state, and a cycle offset state; and wherein the action space comprises a plurality of action policies, and the action policies comprise at least one of the following policies: a longest processing time (LPT) first policy, a shortest processing time (SPT) first policy, a least predecessors (LP) first policy, a most successors (MS) first policy, an optimal cycle time matching (OCTM) policy, and a random policy; and further wherein an objective function is designed based on three objectives of a number of workstations, the disassembly cost, and the disassembly energy consumption, and a multi-objective reinforcement learning model is constructed based on a multi-objective deep Q-network algorithm (MO-DQN algorithm);
the objective function is denoted as:
$$R = - ( {w}_{1} {f}_{1} + {w}_{2} {f}_{2} + {w}_{3} {f}_{3} ) ;$$
wherein w₁, w₂, and w₃ are weight coefficients of various objectives and reflect a relative importance of the various objectives in decision-making to achieve a collaborative optimization among different objectives, f₁ denotes the number of workstations, f₂ denotes the disassembly cost, and f₃ denotes the disassembly energy consumption;
a training unit configured to train the multi-objective reinforcement learning model, wherein the multi-objective reinforcement learning model introduces a preference vector through the MO-DQN algorithm to dynamically adjust objective weights, calculates the objective function based on the disassembly data obtained by the acquisition unit, and optimizes a plurality of objectives defined by the construction unit; and wherein the training unit selects an action policy by combining an E-greedy strategy and a non-dominated sorting genetic algorithm II (NSGA-II), and finally converges to an optimal model capable of balancing the plurality of objectives;
and further wherein during a training process, the MO-DQN algorithm combines a plurality of objective values to form a Q-value function in a vector form, and uses different preference weights as conditional inputs during the training process to learn a generalization mapping from preferences to Q-values, and the NSGA-II performs non-dominated sorting on a multi-objective Q-value vector corresponding to an action and calculates a crowding distance to determine an optimal action; and
an optimization unit configured to perform task scheduling and resource allocation optimization by applying an optimal policy generated by the multi-objective reinforcement learning model that is trained to task assignment in an actual disassembly line.

8. A computer-readable storage medium storing a computer program thereon, wherein the computer program, when executed by a processor, causes the processor to implement the method according to claim 1.
